(19) United States
(12) Patent Application Publication
(10) Pub. No.: US 2024/0206037 A1
(43) Pub. Date: Jun. 20, 2024

(54) An electrical circuit comprising a galvanic isolation between a High Voltage, HV, circuit part and a Low Voltage, LV, circuit part and having an increased creepage distance

(71) Applicant: SIGNIFY HOLDING B.V., EINDHOVEN (NL)

(72) Inventor: BERND ACKERMANN, AACHEN (DE)

(21) Appl. No.: 18/557,076

(22) PCT Filed: Apr. 19, 2022
(86) PCT No.: PCT/EP2022/060278

§ 371 Date: Oct. 25, 2023

(30) Foreign Application Priority Data
Apr. 29, 2021 (EP) 21171110.6

(51) Int. Cl. H05B 45/382; H02M 3/335; H05B 45/385

(52) U.S. Cl. CPC H05B 45/382; H02M 3/335; H05B 45/385

(57) ABSTRACT

An electrical circuit having a galvanic isolation between a High Voltage, HV, circuit part and a Low Voltage, LV, circuit part, wherein said electrical circuit comprises a substrate providing said HV and said LV circuit part, an electrical component for providing said galvanic isolation, said component provided on said substrate and having a primary side connected, with a first primary terminal, to said HV circuit part and a secondary side connected, with a first secondary terminal, to said LV circuit part such that a creepage distance is provided over said substrate between said first primary terminal and said first secondary terminal, a conductive trace provided on said substrate, connected with a first end to a Low Frequency, LF, voltage node in said HV circuit part, wherein a frequency of a voltage potential at said LF voltage node is lower than a frequency of a voltage potential at said first primary terminal, and said conductive trace provided in between said first primary terminal and said first secondary terminal thereby increasing said creepage distance between said first primary terminal and said first secondary terminal.

### TECHNICAL FIELD

The present disclosure is directed to an electrical circuit providing galvanic isolation and, more specifically, to a concept for increasing creepage distance between primary and secondary sides of an electrical component bridging the galvanic isolation in an electrical circuit.

### BACKGROUND

Galvanic isolation is a known principle of electrically isolating two electrical parts of an electrical circuit such that no current will flow between these two electrical parts. That is, there is no conductive part connecting the two electrical parts.

It is still possible to exchange electrical power, or information of some sort, between the electrical parts using electrical components bridging the galvanic isolation. These electrical components may, for example, be a transformer, an optocoupler or a capacitor.

Galvanic isolation is used, for example, for safety purposes. Such an isolation ensures that High Voltages present at a first circuit part are not able to transition to Low Voltages present at an isolated second circuit part as there is no conductive part connecting the two circuits. Galvanic isolation may thus be used for safety, preventing accidental current from reaching ground through a person's body for example.

Galvanic isolation may be used where two or more electric circuit parts need to communicate, but their grounds may be at different potentials. It is an effective method of breaking ground loops by preventing unwanted current from flowing between two units sharing a ground conductor.

Galvanic, i.e. safety, isolation may thus separate the potentially unsafe High Voltage part of a circuit from the safe Low Voltage part of an electrical circuit. Depending on specific conditions, requirements apply for (i) clearance, (ii) creepage distance and (iii) distance through insulation. All of these are expressed as geometric distances (i) through air, (ii) along a surface and (iii) through a solid.

The above indicated requirements may also be met in components bridging the galvanic isolation, like transformers, optocouplers, and X and Y capacitors. That is, these components may be attached to both the High Voltage part of the circuit and the Low Voltage part of the circuit. In these components, the High Voltage part and Low Voltage part of the circuit are coupled to each other by magnetic fields in transformers, by light in optocouplers, by electric fields in X and Y capacitors. Transformers cause power transfer, optocouplers cause information transfer, X and Y capacitors cause transfer of very high frequency currents, which is used to reduce electromagnetic interference (EMI).

One of the downsides of the above is that the above described distances need to be met for assuring correct and safe operation of the electrical circuit, which is at the expense of design freedom.

### SUMMARY

It is an aspect of the present disclosure to provide for an electrical circuit that has improved creepage distances. It is a further aspect of the present disclosure to provide for a Light Emitting Diode, LED, based lighting device as well as a method for providing an electrical circuit in accordance with the present disclosure.

In a first aspect of the present disclosure, there is provided an electrical circuit having a galvanic isolation between a High Voltage, HV, circuit part and a Low Voltage, LV, circuit part, wherein said electrical circuit comprises:
a substrate providing said HV and said LV circuit part;
an electrical component for providing said galvanic isolation, said component provided on said substrate and having a primary side connected, with a first primary terminal, to said HV circuit part and a secondary side connected, with a first secondary terminal, to said LV circuit part such that a creepage distance is provided over said substrate between said first primary terminal and said first secondary terminal;
a conductive trace provided on said substrate, connected with a first end to a Low Frequency, LF, voltage node in said HV circuit part, wherein a frequency of a voltage potential at said LF voltage node is lower than a frequency of a voltage potential at said first primary terminal, and said conductive trace provided in between said first primary terminal and said first secondary terminal thereby increasing said creepage distance between said first primary terminal and said first secondary terminal.

It was the insight of the inventor that the creepage distance that is to be taken into account not only depends on the voltage levels, but also on the frequency of the potentials/voltages at the HV circuit part. The higher the frequency of the potential of a node, the larger the creepage distance of that particular node is to be.

As such, the inventor has found to introduce a conductive trace on the substrate, connected in between the first primary terminal and the first secondary terminal, wherein the conductive trace is connected to the HV circuit part and, more specifically, to a low frequency, LF, voltage node in the HV circuit part.

The creepage requirement for this specific conductive trace is dependent on the voltage at the HV circuit part, but also on the (expected) frequency of the voltage potential of the LF voltage node. In this particular case, the frequency of the voltage potential at the LF voltage node is lower than a frequency of the voltage potential at the first primary terminal such that the creepage requirement for the specific conductive trace is less stringent compared to the creepage requirement for the first primary terminal.

The creepage requirement for the first primary terminal does not change by the introduction of the conductive trace. The actual creepage distance does change as it is no longer possible to creep from the first primary terminal directly to the first secondary terminal. The creepage distance is affected by the introduction of the conductive trace. The creep route cannot cross the conductive trace and, therefore, needs to go around the conductive trace. This increases the actual creepage distance between the first primary terminal and the first secondary terminal.

In an example, the conductive trace is connected, with its first end, to ground. Alternatively, the conductive trace may be connected to the supply voltage at the HV circuit part.

In a further example, the electrical component is any of a transformer, an optocoupler or a capacitor, like an X or Y capacitor.

In an example, the electrical component is a transformer comprising a primary winding having said first primary terminal and having a second primary terminal, wherein said conductive trace is connected with said first end to said second primary terminal.

The transformer is, for example, a transformer used in a Switched Mode Power Supply, SMPS, like a flyback converter. The transformer bridges the galvanic isolation as it provides a magnetic coupling between its primary winding and its secondary winding.

The primary winding may be connected, via the first primary terminal to a switch, for example a Field Effect Transistor, FET and, more specifically, to a Gallium Nitride, GaN, FET or a Silicon Carbide, SiC, FET. The switching behavior of such a FET in the SMPS may cause the voltage potential at the first primary terminal to have a high frequency, i.e. the same frequency with which the gate of the FET is controlled. The primary winding may be connected, via the second primary terminal, to a supply voltage, for example. This means that the voltage potential at the second primary terminal is not switching along with the frequency of the signal provided to the gate of the FET. The voltage potential at the second primary terminal is relatively static in that it equals the supply voltage.

That means that the creepage requirement with respect to the second primary terminal is less stringent compared to the creepage requirement with respect to the first primary terminal. The absolute voltage potentials at these terminals may reach the same values but the frequency of the voltage potentials at these terminals differ.

In a further example, the conductive trace is connected with a second end to the same LF voltage node.

The conductive trace may be floating in the sense that the second end is not connected to any other node in the HV circuit part. It is also noted that the conductive trace may be connected, with the second end, to the same LF voltage node. In that situation, no current will flow through the conductive trace.

In a further example, the electrical component is any of a Surface-Mount Device, SMD, or a through-hole mounted device.

A surface-mount technology may refer to a method in which the electrical component is mounted directly onto the bottom side or the top side of the substrate, for example a Printed Circuit Board, PCB. If that is the case, then the electrical component is referred to as a Surface-Mount Device, SMD. Surface-mount technology may be beneficial as it allows for increased manufacturing automation which reduces, amongst other, costs and improves quality. Further, it may allow for more components to fit on a given area of the substrate.

An SMD component is usually smaller than its through-hole counterpart because it has either smaller leads or no leads at all. It may have short pins or leads of various styles, flat contacts, a matrix of solder balls, or terminations on the body of the component.

In a further example, the electrical component is a through-hole mount device, and wherein said conductive trace is provided on top of said substrate, and wherein said electrical circuit comprises:
a further conductive trace provided at a bottom of said substrate, connected with a first end to said LF voltage node in said HV circuit part, and said further conductive trace provided in between said first primary terminal and said first secondary terminal, at said bottom side of said substrate, thereby increasing said creepage distance between said first primary terminal and said first secondary terminal.

For a through-hole mounted device, the terminals may be connected to the substrate at the top side of the substrate as well as at the bottom side of the substrate. In that case, the required creepage distances need to be met starting from the first primary terminal connected at the top side of the substrate but also starting from the first primary terminal connected at the bottom side of the substrate.

It is noted that the further conductive trace may also be used in case the electrical component is an SMD device, as the advantage may also be obtained when the SMD device is mounted close to the edge of the substrate, i.e. the PCB. In that case, the creepage path may go from top to bottom such that the further conductive trace may also aid in this situation to increase the actual creepage path.

It is further noted that a conductive trace provided at the top of the substrate and the further conductive provided at the bottom of the substrate may be connected to each other at at least one edge of the substrate using, for example, PCB edge plating. In a further example, the substrate is a Printed Circuit Board, PCB.

In another example, the conductive trace extends, in between said first primary terminal and said first secondary terminal, substantially perpendicular to an imaginary direct line between said first primary terminal and said first secondary terminal.

In other words, the direct, line-of-sight, line between the first primary terminal and the first secondary terminal is crossed by the conductive trace, preferable in a substantial perpendicular manner.

In a further example, the electrical circuit comprises a Switched Mode Power Supply, SMPS, for example using Gallium Nitride, GaN or Silicon Carbide, SIC, technology. One of the envisioned next steps towards an energy-efficient world lies in the use of new materials, such as wide bandgap semiconductors which allow for greater power efficiency, smaller size, lighter weight, lower overall cost and sometimes even all of these together.

All kinds of drivers may benefit from small passive components like transformers, inductors, capacitors. Such small passive components may be made possible due to the high switching frequencies enabled by Gallium Nitride, GaN, technology.

The high switching frequencies enabled by GaN, for example from several 100 kHz up to several MHz, result in large minimum creepage distance requirements for safety and/or galvanic isolation. As mentioned above, the creepage distance is not only dependent on the voltage levels but also on frequency levels. The present disclosure is thus especially useful in situations wherein in the HV circuit part relatively high frequencies are used, for example in the range of 70 kHz-20 MHz.

In a further example, there is provided a Light Emitting Diode, LED, based lighting device comprising an electrical circuit in accordance with any of the previous examples.

In another aspect, there is provided a method of providing an electrical circuit having a galvanic isolation between a High Voltage, HV, circuit part and a Low Voltage, LV, circuit part, wherein said method comprises the steps of:
providing a substrate having said HV and said LV circuit part;
assembling an electrical component for providing said galvanic isolation, on said substrate, said electrical component having a primary side connected, with a first primary terminal, to said HV circuit part and a secondary side connected, with a first secondary terminal, to said LV circuit part such that a creepage distance is provided over said substrate between said first primary terminal and said first secondary terminal;
providing a conductive trace on said substrate, connected with a first end to a Low Frequency, LF, voltage node in said HV circuit part, wherein a frequency of a voltage potential at said LF voltage node is lower than a frequency of a voltage potential at said first terminal, and said conductive trace provided in between said first primary terminal and said first secondary terminal thereby increasing said creepage distance between said first primary terminal and said first secondary terminal.

These and other aspects of the invention will be apparent from and elucidated with reference to the embodiment(s) described hereinafter.

### BRIEF DESCRIPTION OF THE DRAWINGS

FIG. 1 discloses an example of an electrical circuit having a galvanic isolation;

FIG. 2 discloses an example of a Printed Circuit Board, PCB, layout comprising a transformer providing the galvanic isolation;

FIG. 3 discloses an example of an actual creepage distance between a High Voltage, HV, circuit part and a Low Voltage, LV, circuit part.

### DETAILED DESCRIPTION

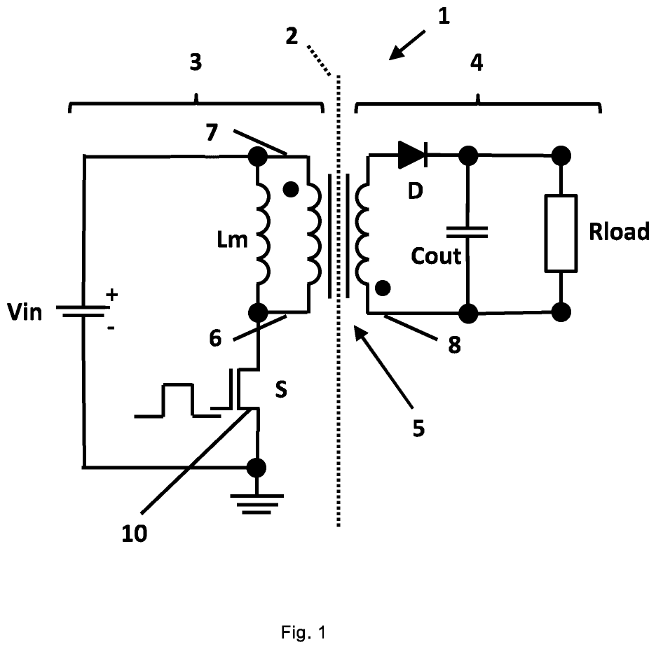

FIG. 1 discloses an example of an electrical circuit 1 having a galvanic isolation as indicated with the dashed line having numeral reference 2.

The electrical circuit 1 shown in FIG. 1 is a so-called flyback converter. A flyback converter may be used in converting Alternating Current, AC, to Direct Current, DC but may also be used in converting DC to DC. The latter is shown in FIG. 1.

The electrical circuit shown in FIG. 1 comprises a High Voltage, HV, circuit part 3 and a Low Voltage, LV, circuit part 4. The High Voltage circuit part 3 may be designed for relatively High Voltages, for example above 48V DC or above 30 Vrms AC, or for example above 400V DC or above 230 Vrms AC, or the like. The Low Voltage circuit part 4 may be designed for relatively Low Voltages, for example lower then 48V DC or lower then 30 Vrms AC or the like.

Galvanic isolation is a principle of isolating the HV circuit part 3 and the LV circuit part 4 of the electrical circuit 1 to prevent current flow between these parts. No direct conduction path is permitted between the circuit parts. Energy or information can still be exchanged between the circuit parts 3, 4 by other means, such as capacitance, induction or electromagnetic waves, or by optical, acoustic or mechanical means.

Galvanic isolation is used where two or more electric circuits must communicate, but their grounds may be at different potentials. It is an effective method of breaking ground loops by preventing unwanted current from flowing between two units sharing a ground conductor. Galvanic isolation is also used for safety, preventing accidental current from reaching ground through a person's body.

Galvanic isolation may be used for ensuring an insulation breakdown threshold to a reasonably safe level as defined by acknowledged standards, for example IEC standards, and international safety bodies.

The electrical circuit 1 comprises a substrate that provides the HV circuit part 3 and the LV circuit part 4. The substrate is not shown in FIG. 1 itself, but it may consist of a carrier like a Printed Circuit Board, PCB, on which the electrical circuit 1 is provided.

The electrical circuit 1 further comprises at least one electrical component 5 that provides the galvanic isolation 2. The electrical component 5 thus bridges the galvanic isolation 2 in that the component 5 has a primary side connected, with a first primary terminal 6, to said HV circuit part 3, and a secondary side connected, with a first secondary terminal 8, to said LV circuit part 4 such that a creepage distance is provided over said substrate between said first primary terminal 6 and said first secondary terminal 8.

The creepage distance may be defined as the shortest distance between two conductive parts measured along the surface of the substrate. In this particular case, a creepage distance may be determined between the first primary terminal 6 and the first secondary terminal 8 over the substrate.

In the electrical circuit 1 shown in FIG. 1, the electrical component 5 may be connected to the HV circuit part 3 with two terminals, i.e. a first primary terminal 6 and a second primary terminal 7. The frequency of the voltage potential at the first primary terminal 6 may be higher compared to the frequency of the voltage potential at the second primary terminal 7 due to the fact that the first primary terminal 6 is connected to the switch 10 of the flyback converter. The topology of the flyback converter is further not disclosed in detail herein and is assumed to be known.

It is further noted that the voltage potential of the first primary terminal 6 and the voltage potential of the second primary terminal 7 may be equivalent.

The inventor has noted that the required creepage distance, for example imposed by corresponding safety standards, not only depends on the expected voltage level at the HV circuit part 3, but also on the frequency of the voltage potential of a corresponding node at the HV circuit part 3. The higher the frequency of the voltage potential, the larger the creepage distance is expected to be.

The inventor has found that the actual creepage distance between the first primary terminal and the first secondary terminal can be influenced by introducing a conductive trace on the substrate in between the first primary terminal and the first secondary terminal.

The conductive trace is connected, with a first end, to a Low Frequency, LF, voltage node in the HV circuit part. This means that the frequency of the voltage potential at the LF voltage node is lower than a frequency of the voltage potential at the first primary terminal. The effect hereof is that the creepage distance required for the conductive trace on the substrate is smaller compared to the creepage distance required for the first primary terminal. This is due to the difference in the frequency of the voltage potential at the first primary terminal and the frequency of the voltage potential at the LF voltage node.

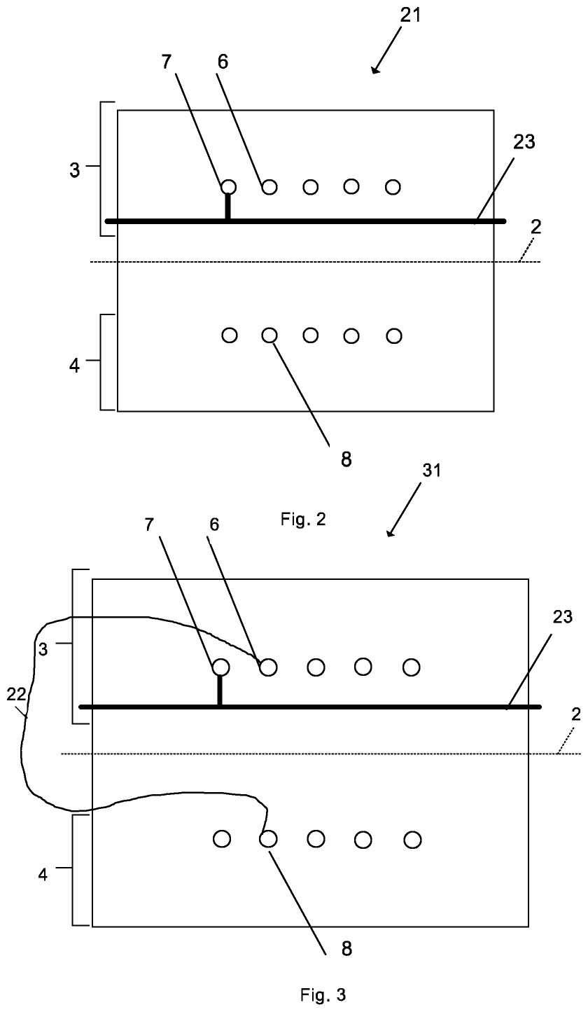

The conductive trace is thus provided in between the first primary terminal 6 and the first secondary terminal 8. This is explained in more detail with reference to FIG. 2.

FIG. 2 discloses an example of a Printed Circuit Board, PCB, layout comprising a transformer providing the galvanic isolation. More specifically, a PCB footprint 21 is shown of the transformer.

The footprint 21 again shows the HV circuit part 3 and the LV circuit part 4 as well as the galvanic isolation 2.

The first primary terminal is, again, indicated with reference numeral 6. The second primary terminal is indicated with reference numeral 7. The first secondary terminal is indicated with reference numeral 8. The conductive trace is indicated with reference numeral 23.

As shown in FIG. 2, the conductive trace 23 is provided in between the primary side and the secondary side of the transformer. This directly affects the actual creepage route between the primary and the secondary side of the transformer, as is also shown in the footprint 31 FIG. 3.

In FIG. 3, the actual creepage route 22, and thereby thus also the actual creepage distance, between the primary side and the secondary side of the transformer is influenced by the introduction of the conductive trace 23. The creepage route is not the shortest distance between the primary pins of the transformer and the secondary pins of the transformer. The creepage route needs to circumvent the conductive trace 23 as shown in FIG. 3. The creepage route 22 passes partly through air. This means that creepage distance requirements do no longer apply but only clearance requirements that are less stringent at high frequencies.

In this particular example, the conductive trace 23 is connected with one end to a Low Frequency, LF, voltage node being a second primary terminal 7. It is noted, however, that, preferably, the conductive trace may be connected, with said first end, to ground. The second end of the conductive trace may be connected to the same node, for example also to ground.

The advantages of the present disclosure have been explained with respect to a transformer being the electrical component 5. It is however noted that the advantages of the present disclosure are applicable for all kinds of electrical components that bridge a galvanic isolation, for example an optocoupler and a capacitor.

Other variations to the disclosed embodiments can be understood and effected by those skilled in the art in practicing the claimed invention, from a study of the drawings, the disclosure, and the appended claims. In the claims, the word “Comprising” does not exclude other elements or steps, and the indefinite article “a” or “an” does not exclude a plurality. The mere fact that certain measures are recited in mutually different dependent claims does not indicate that a combination of these measures cannot be used to advantage.

Any reference signs in the claims should not be construed as limiting the scope thereof.

1. A switched mode power supply comprising an electrical circuit having a galvanic isolation between a High Voltage (HV) circuit part and a Low Voltage (LV) circuit part, wherein said electrical circuit comprises:
a substrate providing said HV and said LV circuit part;
an electrical component for providing said galvanic isolation, said component provided on said substrate and having a primary side connected, with a first primary terminal, to said HV circuit part and a secondary side connected, with a first secondary terminal, to said LV circuit part such that a creepage distance is provided over said substrate between said first primary terminal and said first secondary terminal; and
a conductive trace provided on said substrate, connected with a first end to a Low Frequency (LC) voltage node in said HV circuit part, wherein a frequency of a voltage potential at said LF voltage node is lower than a frequency of a voltage potential at said first primary terminal, and said conductive trace provided in between said first primary terminal and said first secondary terminal thereby increasing said creepage distance between said first primary terminal and said first secondary terminal.

2. The switched mode power supply in accordance with claim 1, wherein said Low Frequency (LF) voltage node is ground.

3. The switched mode power supply in accordance with claim 1, wherein said electrical component is any of:
a transformer;
an optocoupler;
a capacitor.

4. The switched mode power supply in accordance with claim 1, wherein said electrical component is a transformer comprising a primary winding having said first primary terminal and having a second primary terminal, wherein said conductive trace is connected with said first end to said second primary terminal.

5. The switched mode power supply in accordance with claim 1, wherein said conductive trace is connected with a second end to the same LF voltage node.

6. The switched mode power supply in accordance with claim 1, wherein said electrical component is any of a Surface-Mount Device (SMD) or a through-hole mounted device.

7. The switched mode power supply in accordance with claim 6, wherein said electrical component is a through-hole mounted device, and wherein said conductive trace is provided on top of said substrate, and wherein said electrical circuit comprises:
a further conductive trace provided at a bottom of said substrate, connected with a first end to said LF voltage node in said HV circuit part, and said further conductive trace provided in between said first primary terminal and said first secondary terminal, at said bottom side of said substrate, thereby increasing said creepage distance between said first primary terminal and said first secondary terminal.

8. The switched mode power supply in accordance with claim 1, wherein said substrate is a Printed Circuit Board (PCB).

9. The switched mode power supply in accordance with claim 1, wherein said conductive trace extends, in between said first primary terminal and said first secondary terminal, perpendicular to an imaginary direct line between said first primary terminal and said first secondary terminal.

10. The switched mode power supply in accordance with claim 1, wherein said electrical circuit comprises a Switched Mode Power Supply (SMPS).

11. The switched mode power supply in accordance with claim 10, wherein said SMPS uses Gallium Nitride (GaN) technology.

12. A Light Emitting Diode (LED) based lighting device comprising the switched mode power supply in accordance with claim 1.

13. A method of providing a switched mode power supply comprising an electrical circuit having a galvanic isolation between a High Voltage (HV) circuit part and a Low Voltage (LV) circuit part, wherein said method comprises:
providing a substrate having said HV and said LV circuit part;
assembling an electrical component for providing said galvanic isolation, on said substrate, said electrical component having a primary side connected, with a first primary terminal, to said HV circuit part and a secondary side connected, with a first secondary terminal, to said LV circuit part such that a creepage distance is provided over said substrate between said first primary terminal and said first secondary terminal; and
providing a conductive trace on said substrate, connected with a first end to a Low Frequency, LF, voltage node in said HV circuit part, wherein a frequency of a voltage potential at said LF voltage node is lower than a frequency of a voltage potential at said first primary terminal, and said conductive trace provided in between said first primary terminal and said first secondary terminal thereby increasing said creepage distance between said first primary terminal and said first secondary terminal.
